(19) United States
(12) Patent Application Publication
(10) Pub. No.: US 2009/0137616 A1
(43) Pub. Date: May 28, 2009

(54) METHOD FOR THE CONTROL OF PHYTOPATHOGENIC FUNGI

(75) Inventors: Clifford George Watrin, Greensboro, NC (US); Gilberto Olaya, Vero Beach, FL (US)

Correspondence Address: SYNGENTA CROP PROTECTION , INC.;PATENT AND TRADEMARK DEPARTMENT, 410 SWING ROAD, GREENSBORO, NC, 27409, US

(73) Assignee: Syngenta Crop Protection, Inc., Greensboro, NC (US)

(21) Appl. No.: 11/813,057

(22) PCT Filed: Dec. 27, 2005
(86) PCT No.: PCT/EP2005/014048

§ 371 Date: May 30, 2008

Related U.S. Application Data
(60) Provisional application No. 60/639,466, filed on Dec. 28, 2004.

(51) Int. Cl. A01N 43/54; A01P 3/00

(52) U.S. Cl. 514/269

(57) ABSTRACT

The present invention provides a method of controlling Pythium infection of plants comprising treating the plant or plant propagation material with a strobilurin, in particular, wherein the Pythium species is phenylamide insensitive. In addition, the present invention provides for use of a strobilurin for control of Pythium infection of a plant.

The present invention relates to a method of controlling Pythium infection of plants by treatment of the plant, or a plant part, with a strobilurin fungicide. More particularly, it relates to a method of controlling phenylamide-insensitive Pythium infection.

Fungi of the genus Pythium are know to be pathogenic to many plants. A standard treatment against such fungi is the use of a phenylamide fungicide such as metalaxyl or mefenoxam. However, recently, it has been noticed that resistance of Pythium to such fungicide treatment is increasing. We have isolated fungal pathogens from plant and soil material, identified Pythium species and found isolates insensitive to phenylamide fungicides. Unexpectedly, we have now found that strobilurin fungicides (in particular, azoxystrobin), that were previously not known to control such fungal infection, have excellent activity against Pythium species and that Pythium isolates that are insensitive to phenylamide fungicides are, surprisingly, sensitive to strobilurins, and therefore lead in an improvement in growth of a plant.

Accordingly, the present invention provides a method of controlling Pythium infection of plants comprising treating the plant or plant propagation material with a strobilurin. In one embodiment, the Pythium species is phenylamide insensitive. In a further embodiment, the Pythium species is selected from the group consisting of Pythium arrhenomanes, Pythium aristosporum, Pythium attranitheridium, Pythium irregulare, Pythium sylvaticum, Pythium ultimum, Pythium heterothallicum, Pythium torulosum, or Pythium dissotocum.

In another embodiment, the strobilurin is azoxystrobin, fluoxastrobin, trifloxystrobin, dimoxystrobin, fenamidone, pyraclostrobin, famoxodone, metominostrobin, kresoxim-methyl or picoxystrobin.

In another embodiment, seed is treated. In a further embodiment, seed of cotton, corn, soybeans, rice or peanuts is treated.

In another embodiment, the present invention provides for the use of a strobilurin for control of Pythium infection of a plant, particularly phenylamide insensitive pythium infection.

The active ingredient for use in the method of the invention is a strobilurin fungicide such as, azoxystrobin, fluoastrobin, trifloxystrobin, dimoxystrobin, fenamidone, pyraclostrobin, famoxodone, metominostrobin, kresoxim-methyl and picoxystrobin; preferably azoxystrobin, fluoastrobin, trifloxystrobin, and picoxystrobin. See, for example, the Pesticide Manual, 13^{th} Ed. 2003, The British Crop Protection Council, London, pages 52, 786, 595 and 1007, respectively.

The method of the present invention is suitable for controlling species of the genus Pythium, in particular, but not limited to, Pythium acanthicum, Pythium adhaerens, Pythium angustatum, Pythium aphanidermatum, Pythium arrhenomanes, Pythium debaryanum, Pythium dissotocum, Pythium festivum, Pythium graminicola, Pythium irregulare, Pythium monospermum, Pythium paroecandrum, Pythium pulchrum, Pythium rostratum, Pythium spinosum, Pythium splendens, Pythium sylvaticum, Pythium ultimum, Pythium heterothallicum, Pythium torulosum and Pythium vexans.

Preferably the phenylamide insensitive Pythium species is selected from Pythium arrhenomanes, Pythium aristosporum, Pythium attrantheridium, Pythium irregulare, Pythium sylvaticum, Pythium ultimum, Pythium dissotocum, Pythium heterothallicum and Pythium torulosum.

In an embodiment of the invention, the plant or plant propagation material is treated also with a further pesticide either simultaneously or in succession to the strobilurin fungicide.

The strobilurin fungicide of the invention is particularly used in combination with one or more other fungicides and insecticides, for example, to broaden the disease control spectrum and/or for convenience. Examples of fungicides include phenylamide and triazoles. In particular, a preferred combination is a strobilurin fungicide, such as trifloxystrobin, fluaxostrobin or azoxystrobin, with a suitable phenylamide fungicide, such as benalaxyl, benalaxyl-M, metalaxyl and mefenoxam (metalaxyl-M).

The method of the present invention is suitable for controlling Pythium infection of a number of target crops including, but not limited to: cereals (wheat, barley, rye, oats, maize, rice, sorghum and related crops); beet (sugar beet and fodder beet); leguminous plants (beans, lentils, peas, soybeans); oil plants (rape, mustard, sunflowers); cucumber plants (marrows, cucumbers, melons); fibre plants (cotton, flax, hemp, jute); vegetables (spinach, lettuce, asparagus, cabbages, carrots, eggplants, onions, pepper, tomatoes, potatoes, paprika); nust (such as almonds, pistachio, and peanuts), as well as ornamentals (flowers, shrubs, broad-leaved trees and evergreens, such as conifers). In particular, the method of the present invention is particularly useful for control of Pythium species on corn and soybean.

The active ingredient according to the invention is especially advantageous for the treatment of plant propagation material, especially seeds. In particular, the active ingredient is suitable for treatment of the plant propagation material of cotton, corn (including field corn, sweetcorn and popcorn), soybeans, rice and peanuts. The active ingredient may be used for dressing applications on plant propagation material to provide protection against fungus infections on the plant propagation material as well as against phytopathogenic fungi occurring in the soil.

By ‘plant propagation material’ is meant seeds of all kinds (fruit, tubers, bulbs, grains etc), cuttings, cut shoots and the like.

The active ingredient for use in the method of the present invention is also suitable for foliar application in living crops of plants.

The active ingredient may be used in unmodified form but is normally used in the form of compositions. It can be applied together with further carriers, surfactants or other application-promoting adjuvants customarily employed in formulation technology. Suitable carriers and adjuvants can be solid or liquid and are the substances ordinarily employed in formulation technology, e.g. natural or regenerated mineral substances, solvents, dispersants, wetting agents, tackifiers, thickeners, binders or fertilizers.

The active ingredient is conveniently formulated in known manner e.g. into emulsifiable concentrates, coatable pastes, directly sprayable or dilutable solutions, dilute emulsions, wettable powders, soluble powders, dusts, granules, or by encapsulation in e.g. polymer substances. As with the nature of the compositions, the methods of application, such as spraying, atomising, dusting, scattering, coating or pouring, are chosen in accordance with the intended objectives and the prevailing circumstances. Advantageous rates of application of the active ingredient are normally from 0.5 g to 400 g a.i./ha, or from 1 g to 250 g a.i/ha. In the case of treatment of seed, advantageous rates of application of the active ingredient are generally from 0.5 g to 500 g, preferably from 1 g to 100 g, or from 5 g to 50 g a.i. per 100 kg of plant propagation material, especially seed.

One method of applying the active ingredient of the present invention is foliar application. The frequency of application and the rate of application will depend on the risk of infestation by the fungal pathogen. However, the active ingredient can also penetrate the plant through the roots via the soil (systemic action) by drenching the locus of the plant with a liquid formulation, or by applying the active ingredients in solid form to the soil, e.g. in granular form (soil application).

In a particularly suitable method, the active ingredient may be applied to plant propagation material to be protected by impregnating the plant propagation material, in particular, seeds, either with a liquid formulation comprising the strobilurin fungicide or coating it with a solid formulation. In special cases, other types of application are also possible, for example, the specific treatment of plant cuttings or twigs serving propagation.

The formulations are prepared in known manner, e.g. by homogeneously mixing and/or grinding the active ingredients with extenders, e.g. solvents, solid carriers and, where appropriate, surface-active compounds (surfactants).

Suitable solvents are: aromatic hydrocarbons, preferably the fractions containing 8 to 12 carbon atoms, e.g. xylene mixtures or substituted naphthalenes, phthalates, such as dibutyl phthalate or dioctyl phthalate, aliphatic hydrocarbons, such as cyclohexane or paraffins, alcohols and glycols and their ethers and esters, such as ethanol, ethylene glycol, ethylene glycol monomethyl or monoethyl ether, ketones, such as cyclohexanone, strongly polar solvents, such as N-methyl-2-pyrrolidone, dimethyl sulphoxide or dimethylformamide, as well as vegetable oils or epoxidised vegetable oils, such as epoxidised coconut oil or soybean oil; or water.

The solid carriers used, e.g. for dusts and dispersible powders, are normally natural mineral fillers, such as calcite, talcum, kaolin, montmorillonite or attapulgite. In order to improve the physical properties it is also possible to add highly dispersed silicic acid or highly dispersed absorbent polymers. Suitable granulated adsorptive carriers are porous types, for example pumice, broken brick, sepiolite or bentonite, and suitable nonsorbent carriers are, for example, calcite or sand. In addition, a great number of pregranulated materials of inorganic or organic nature can be used, e.g. especially dolomite or pulverised plant residues.

Depending upon the nature of the active ingredient to be formulated, suitable surface-active compounds are non-ionic, cationic and/or anionic surfactants having good emulsifying, dispersing and wetting properties. The term ‘surfactants’ will also be understood as comprising mixtures of surfactants.

The surfactants customarily employed in formulation technology may be found in the following literature:

### “McCutcheon's Detergents and Emulsifiers Annual” MC Publishing Corp., Glen Rock, N.J., 1988.

M. and J. Ash, “Encyclopedia of Surfactants”, Vol. I-III, Chemical Publishing Co., New York, 1980-1981.

Particularly advantageous application-promoting adjuvants are also natural or synthetic phospholipids of the cephalin and lecithin series, e.g. phosphatidylethanolamine, phosphatidylserine, phosphatidylglycerol and lysolecithin.

The agrochemical compositions normally comprise 0.1 to 99%, especially 0.1 to 95%, active ingredient, 99.9 to 1%, especially 99.9 to 5%, of a solid or liquid adjuvant and 0 to 25%, especially 0.1 to 25%, of a surfactant.

Whereas commercial products or wet or dry dressings will preferably be formulated as concentrates, the end user will normally employ dilute formulations for treating plants or seeds as the case may be. However, ready to apply dilute solutions also are within the scope of the present invention.

The invention will now be described with reference to the following examples:

### EXAMPLES

### Example 1

Plant and soil samples were collected from fields where plant stand establishment issues appeared to be increasing when using standard mefenoxam or metalaxyl seed treatment fungicide programs. Fungal pathogens were isolated from the plant and soil material. Pythium species were identified and studies were conducted to determine the sensitivity of these fungal pathogens to phenylamide and strobilurin fungicides. The results of these investigations are shown in Tables 1 & 2 below. It can be seen that isolates from several species of Pythium that are insensitive to mefenoxam are sensitive to azoxystrobin or trifloxystrobin.

TABLE 1

| | | | |
|---|---|---|---|
| | | Mefenoxam | Azoxystrobin |
| Isolate | Origin | ED50 (mg/L) | ED50 (mg/L) |

Pythium arrhenomanes

| | | | |
|---|---|---|---|
| 03-117 | Iowa | 1.758 | 0.008 |
| 03-131 | Iowa | 2.479 | 0.010 |
| 03-783 | Ohio | 3.540 | 0.004 |
| 03-122 | Iowa | 1.668 | 0.009 |
| 03-123 | Iowa | 0.926 | 0.008 |

Pythium irregulare

| | | | |
|---|---|---|---|
| 03-046 | Michigan | 0.570 | 0.141 |
| 03-053 | Michigan | 0.510 | 0.183 |
| 03-165 | Iowa | 0.033 | 0.155 |
| 03-250 | New York | 0.060 | 0.304 |
| 03-879 | Nebraska | 0.670 | 0.075 |

Pythium aristosporum

| | | | |
|---|---|---|---|
| 03-121 | Iowa | 0.518 | 0.008 |
| 03-129 | Iowa | 0.323 | 0.009 |
| 03-136 | Iowa | 3.398 | 0.009 |
| 03-670 | Ohio | >100 | 0.026 |
| 03-867 | Nebraska | 4.530 | 0.008 |

Pythium ultimum

| | | | |
|---|---|---|---|
| 03-047 | Michigan | 0.015 | 0.049 |
| 03-293 | Indiana | 0.010 | 0.066 |
| 03-795 | Minnesota | 0.090 | 0.037 |
| 03-796 | Minnesota | 0.080 | 0.040 |
| 03-835 | Illinois | 0.030 | 0.059 |

Pythium attrantheridium

| | | | |
|---|---|---|---|
| 03-425 | Ohio | 0.136 | 0.031 |
| 03-445 | Ohio | >100 | 0.020 |
| 03-477 | Ohio | 0.020 | 0.031 |
| 03-649 | Ohio | 6.730 | 0.065 |
| 03-673 | Ohio | 0.120 | 0.077 |

Pythium sylvaticum

| | | | |
|---|---|---|---|
| 03-050 | Michigan | 0.051 | 0.062 |
| 03-083 | Iowa | 0.025 | 0.107 |
| 03-268 | New York | 0.010 | 0.149 |
| 03-379 | Iowa | 0.172 | 0.064 |
| 03-763 | Ohio | >100 | 0.018 |

Pythium dissotocum

| | | | |
|---|---|---|---|
| 03-167 | Iowa | 2.951 | 0.012 |
| 03-256 | New York | 3.590 | 0.020 |
| 03-623 | Ohio | 8.590 | 0.024 |
| 03-194 | Iowa | 0.220 | 0.001 |
| 03-658 | Ohio | 0.020 | 0.031 |

Note to Table 1:
The sensitivity of each Pythium isolate to mefenoxam and azoxystrobin was determined by comparing the colony radial growth of each isolate on potato dextrose agar (PDA) plates amended or not with mefenoxam or azoxystrobin. Mefenoxam technical grade was used to amend the PDA plates to the following concentrations: 0, 0.01, 0.1, 1.0, 10 and 100 mg/L. Azoxystrobin technical grade was used to amend the PDA plates to the following concentrations: 0, 0.001, 0.01, 0.1, 1 and 10 mg/L. The medium was also amended with 100 mg/L of salicylhydroxamic acid (SHAM) to inhibit the alternative oxidase respiratory pathway. The plates were incubated at 20° C. for 2-5 days. The sensitivity test was set in a completely randomized design with two replications for every concentration of mefexoxam or azoxystrobin.

TABLE 2

| | | | | Trifloxy- |
|---|---|---|---|---|
| | | Mefenoxam | Azoxystrobin | strobin |
| | | ED50 | ED50 | ED50 |
| Isolate | Pythium species | (mg/L) | (mg/L) | (mg/L) |
| 03-121 | P. arrhenomanes | 0.518 | 0.023 | 0.114 |
| 03-136 | P. arrhenomanes | 3.398 | 0.020 | 0.101 |
| 03-117 | P. arrhenomanes | 1.758 | 0.024 | 0.106 |
| 03-131 | P. arrhenomanes | 2.479 | 0.021 | 0.104 |
| 03-261 | P. dissotocum | 9.730 | 0.024 | 0.194 |
| 03-461 | P. dissotocum | 2.380 | 0.019 | 0.164 |
| 03-446 | P. attrantheridium | >100 | 0.053 | 0.002 |
| 03-053 | P. irregulare | 0.510 | 0.080 | >10 |
| 03-716 | P. sylvaticum | 0.110 | 0.169 | >10 |
| 03-047 | P. ultimum | 0.015 | 0.208 | >10 |
| 03-293 | P. ultimum | 0.010 | 0.113 | 8.747 |
| 03-795 | P. ultimum var. | 0.090 | 0.141 | 4.864 |
| | sporangiiferum | | | |

Note to Table 2:
The sensitivity of each Pythium isolate to mefenoxam and azoxystrobin or triloxystrobin was determined by comparing the colony radial growth of each isolate on potato dextrose agar (PDA) plates amended or not with mefenoxam, azoxystrobin or trifloxystrobin. Mefenoxam technical grade was used to amend the PDA plates to the following concentrations: 0, 0.01, 0.1, 1.0, 10 and 100 mg/L. Azoxystrobin or trifloxystrobin technical grade was used to amend the PDA plates to the following concentrations: 0, 0.001, 0.01, 0.1, 1 and 10 mg/L. The media with azoxystrobin or trifloxystrobin was also amended with 100 mg/L of salicylhydroxamic acid (SHAM) to inhibit the alternative oxidase respiratory pathway. The plates were incubated at 20° C. for 2-5 days. The sensitivity test was set in a completely randomized design with two replications for every concentration of mefexoxam or azoxystrobin or trifloxystrobin.

### Example 2

Seeds of the Pioneer hybrid 34M95 were untreated and treated with mefenoxam, azoxystrobin or trifloxystrobin at the rates described in Table 3. To test the efficacy of the seed treatment fungicides pasteurized soil was infested with each isolate of Pythium at a rate of 7.8% (volume of inoculum/volume of soil). All these studies were done under greenhouse conditions, and data presented as a comparison against uninoculated seeds.

TABLE 3

| | P. ultimum 03-047 | |
|---|---|---|
| Treatment | % stand reduction | % fresh weight reduction |
| Untreated inoculated | 20.0 | 18.9 |
| Azoxystrobin | 0.0 | 7.9 |
| (1 g a.i/100 KgSeeds) | | |
| Mefenoxam | 6.7 | 5.2 |
| (2 g a.i/100 KgSeeds) | | |
| Trifloxystrobin | 0.0 | 0.0 |
| (5 g a.i/100 KgSeeds) | | |
| | P. ultimum 03-795 | |
| Treatment | % stand reduction | % fresh weight reduction |
| Untreated inoculated | 20.0 | 45.4 |
| Azoxystrobin | 6.7 | 24.7 |
| (1 g a.i/100 KgSeeds) | | |
| Mefenoxam | 6.7 | 15.3 |
| (2 g a.i/100 KgSeeds) | | |
| Trifloxystrobin | 6.7 | 24.1 |
| (5 g a.i/100 KgSeeds) | | |

1. A method of controlling Pythium infection of plants comprising treating the plant or plant propagation material with a strobilurin.

2. The method of claim 1, wherein the Pythium species is phenylamide insensitive.

3. The method of claim 1, wherein the Pythium species is selected from the group consisting of Pythium irregulare, Pythium arrhenomanes, Pythium aristosporum, Pythium ultimum, Pythium attrantheridium, Pythium sylvaticum or Pythium dissotocum.

4. The method of claim 1, wherein the strobilurin is azoxystrobin or trifloxystrobin.

5. The method of claim 1, wherein seed is treated.

6. The method of claim 5, wherein seed of cotton, corn, soybeans, rice or peanuts is treated.

7. The method of claim 1, wherein the plant or plant propagation material is treated also with a further pesticide either simultaneously or in succession to the strobilurin fungicide.

8. (canceled)
